(19) United States
(12) Patent Application Publication
(10) Pub. No.: US 2008/0180200 A1
(43) Pub. Date: Jul. 31, 2008

(54) Double acting electro-magnetic actor

(76) Inventor: Jonathan Bruce Gamble, Naperville, IL (US)

Correspondence Address: JACOBSON HOLMAN PLLC, 400 SEVENTH STREET N.W., SUITE 600, WASHINGTON, DC, 20004, US

(21) Appl. No.: 12/010,802

(22) Filed: Jan. 30, 2008

(30) Foreign Application Priority Data
Jan. 30, 2007 (DE) 10 2007 005 434.5

(51) Int. Cl. H01F 7/08

(52) U.S. Cl. 335/234

(57) ABSTRACT

The invention refers to a double acting electromagnetic actor, in particular for hydraulic and pneumatic applications, with a coil, an armature arranged in the coil with at least two permanent magnets magnetised in axial direction, and a central disc between the permanent magnets, wherein between the armature and the coil in axial direction stronger or easily magnetisable areas are formed, and between these a weakly or non-magnetisable area is formed. The invention is characterised in that the armature is arranged, in particular supported, in a pole tube provided in the coil.

### BACKGROUND OF THE INVENTION

The invention refers to a double acting electro-magnetic actor, in particular for hydraulic and pneumatic applications, with a coil, an armature arranged in the coil with at least two permanent magnets magnetised in axial direction, and a central disc between the permanent magnets, wherein between the armature and the coil in axial direction areas are provided which can be magnetised stronger or easily, and between these an area forms which is weakly or not-magnetised at all.

Double acting electro-magnetic actors are known in hydraulic and pneumatic applications. They can, if connected with a valve, switch the valve in three positions.

DC magnets for operating hydraulic valves have been usual for many years. DC magnets of this type, however, have at least two limiting qualities. The power is only generated in one direction. Double acting magnets with two magnet bodies on a tube are comparatively long and prone to damages. Besides, the inductance of a coil is relatively high which slows down the magnets. Furthermore, the inductance is dependent on the stroke. This variable inductance may lead to problems of stability in control circuit applications. Therefore bi-directional electro-magnetic actors with double acting power have been developed. The advantages with these is that in a case of emergency, when power fails, the valve falls back to a failure-proof point.

### BRIEF SUMMARY OF THE INVENTION

It is the object of the present invention to create a double acting electromagnetic actor in the way mentioned in the beginning which is constructed simply and economically and works reliably.

According to the invention the problem is solved in that the armature is arranged in a pole tube, in particular supported, which is provided in the coil. The pole tube creates space for moving where the armature can work reliably. The pole tube has the task of holding the armature or the armature rod. Thus it forms an opportunity for connecting the actor according to the invention to the influencing element, for example an actuating arrangement, a valve or the like. Basically it is also possible to realise here a suitably sealed connection where the pole tube, preferably formed in one piece, protects the sensitive electronic, namely in particular the coil form and the winding, as the medium may possibly get in the pole space which is, however, sealed towards the coil. Furthermore, the pole space has the task to provide a support of the armature, if necessary. As the armature is arranged on the armature rod, the support of the armature is done also indirectly, if necessary (also according to the invention), via the armature rod which is supported in suitable bearings in the pole space. However, it is also possible to realise an individual support of the armature rod, for example by a suitable slide bearing. By means of that a reliable operation of the actor is guaranteed, wherein in the design of the actor it can preferably be fallen back upon components as they are known in the field of solenoid production so that the result is also an economic realisation of the invention.

In a preferred modification of the invention it is provided that the pole tube is designed pressure sealed. In this case it is possible that the pole space holding the armature can also be a part of the medium circulation which can be influenced by the actor. The pressure sealed design achieves that, of course, there is no medium loss even under pressure in the actor, and, on the other hand, it also secured that no medium, which may be aggressive, can attack the electro-conductive areas or other areas of the actor.

In connection with the double acting actor according to the invention it has to be mentioned that the way of functioning of the actor depends on the design of the weakly or non-magnetic area in proportion to the stronger or easily magnetisable area. In the further course therefore the basically stronger magnetisable area is described as “magnetisable area”, and the weakly or non-magnetic area basically as “non magnetisable area” without the intention of reducing the invention exactly to this special case of application, in particular of the non-magnetic area. It is clear that, according to the invention, it is decisive that the magnetisation is in any case less in the weakly or non-magnetic area than in the stronger or easily magnetisable area in order to act according to the invention.

The pole tube leads additionally to a reinforcement of the magnetic field generated by the coil if the pole tube is made preferably from a magnetisable material. The generated magnetic field power is about proportional to the input current.

In a preferred modification of the invention it is provided that the pole tube has the stronger or easily magnetisable areas and the weakly or non-magnetisable area. Cleverly the different functions of the apparatus are integrated in the available components in order to reduce the number of components. Besides the task of the pole tube to form a holding device for the armature, the pole tube thus comprises also the task to provide the magnetisable or non-magnetic area. Here it has, of course, taken into consideration that the invention also comprises solutions where the pole tube does not influence the magnetic properties of the apparatus, and the magnetisable area or the non-magnetic area are realised by additional elements, for example a sleeve or a tube which may be arranged inside or outside the pole tube.

According to the invention a symmetric construction of the armature with reference to a center plane of the coil is suggested. As center plane of the coil here a plane vertical to the coil axis is seen serving as symmetric plane of the coil. Such a design achieves that the way of function of the actor is essentially the same in both directions.

A similar result is reached in that a symmetric arrangement of the strongly or easily magnetisable area and the weakly or non-magnetisable area is provided with reference to a center plane of the coil.

Besides this basically symmetric construction of the invention it is, however, also possible to provide a construction of the armature symmetric with reference to the center plane of the coil or an arrangement of the strongly or easily magnetisable area or the weakly or non-magnetic area. In this case then the attitude of the characteristic line and the two directions of the stroke differs, however, the attitude can also be influenced and thus corrected by the special design of the limiting surfaces between the magnetisable area or the non-magnetisable area. Thus it can be achieved, for example, that the design of an asymmetric actor in regard of the limited surface is influenced in such a way that it has a symmetric course of the characteristic line or it has the course of the characteristic lines like the one with a symmetric designed actor.

In order to be able to keep or to transfer the armature with arranged permanent magnets to a pole space of the pole tube in a center position as failure resistant position, the weakly or non-magnetic area is designed centered to this pole space.

In a modification of the invention it is provided that the non-magnetic area is designed as air gap. For example, the pole tube is formed by two part tubes which are spaced apart accordingly in order to generate the air gap. However, it is also possible to divide a separate element, for example a suitable sleeve or a tube, which forms the magnetisable area, in two part elements, and to space them apart in order to provide also an air gap for forming the non-magnetic area with a continuous pole tube.

However, it is convenient that the non magnetic part consists of solid material so that the pole tube has a corresponding mechanic stability, and can also be mounted easier, as this is then in one machining step machined accordingly and aligned, and a separate alignment of the two part tubes is not necessary. The non-magnetic area can be made, for example, of a non-magnetisable metallic material. This is in particular important in order to better connect material sealing the area arranged in axial direction on both sides, which is sleeve- or ring- or tube-shaped, or the stronger magnetic part.

With particularly easy applications or certain applications where, for example, the magnetic area is made from a synthetic compound material the weakly or non-magnetisable area can be made of a non-magnetisable synthetic material or synthetic compound material.

In order to provide a particularly simple construction of the double acting electro-magnetic actor the pole tube is already designed together with the weakly or non-magnetic area.

In order to create particular magnet power characteristics and magnetic properties with an energy consumption as small as possible at the coil, the pole space, where the permanent magnets are located, extends only beyond half of the coil. The other half is preferably magnetisable solid material which enforces the magnetic effect of the coil.

Here also the pole space extends to the side opposite the armature rod beyond the coil, and is sealed there accordingly by a plug. The result is an asymmetric construction of the actor. However, it is also possible to realise a corresponding symmetric construction where then the height of the pole space extends only beyond about half of the height of the coil, and the entire assembly is orientated symmetrically with reference to the center plane.

Because of such an arrangement the non-magnetic area is arranged in the pole tube in the inoperative position of the armature in axial direction about opposite the central disc. Such a design has the effect that even in the powerless condition of the actor (for example when the power fails) the position of the armature is pre-defined, and can be used, for example, for suitably security relevant applications of the device according to the invention.

The permanent magnets magnetised in axial direction are arranged on the armature in such a way that the polarisation is symmetric with reference to the central disc. Thus a double acting stroke movement of the armature is achieved wherein the armature moves, depending on the direction of the current flow, in the coil in either direction.

In a preferred modification of the invention it is provided that linked to the front sides of the permanent magnets one disc each is arranged. The construction of the armature according to the invention is derived from the conventional design of the armature. The result is therefore that the permanent magnet is imbedded cleverly symmetrically on the known design of the armature, and on the side opposite the central disc of the permanent magnet another disc is connected. For an attitude of the characteristic line as symmetric as possible it is convenient here that, of course, also the armature has an accordingly symmetric construction, that means the thickness of the exterior discs is identical. Also the thickness of the permanent magnets is cleverly the same. Of course, however, the thickness of the permanent magnets can differ from the thickness of the exterior discs.

In order to improve the magnetic properties so that in particular smaller magnets can be used and the construction altogether becomes more economic, the disc connected to the permanent magnets is at least a ferromagnetic pole disc.

The central disc between the permanent magnets can be made of a non-magnetic or weakly magnetic material or, preferably, as described above, for improving the magnetic properties from a ferromagnetic material.

In order to modify the power characteristic advantageously for certain applications, that means to change it, the central disc can have a larger diameter than the pole discs and the permanent magnets. For the smaller diameter of the (graded) armature the interior diameter of the pole tube is reduced at both ends by inserting standard bearing bushes made of ferromagnetic material and equipped with a suitable glide coating, in the pole space of the pole tube. The permanent magnets and the pole discs thus each are guided in bearing bushes. Conveniently, the central disc is about the same width as the non-magnetic area.

For a simple and economic construction and assembly as well as an enforced magnetic power field the armature has an armature rod on which the pole discs, the permanent magnets and the central disc are arranged.

As the double acting electro-magnetic actor is created in particular for pneumatic or hydraulic applications where the pole tube is in contact with the fluid, and the pole tube is designed, in particular, pressure sealed, the armature rod has a passage boring for pressure compensation.

In a preferred modification of the invention it is provided that the magnetisable area is linked at a limiting surface to the non-magnetic area, and the thickness of the magnetisable area is reduced in the area of the limiting surface with reference to the (interior) armature, either starting from the inside to the outside or starting from the outside to the inside. The modifications described here are shown in particular in FIG. 9 and FIG. 10. Exactly the design of the end area of the magnetisable area in direction to the non-magnetic area (also described as pole core) influences in a decisive way the design of the characteristic line of the actor according to the invention. Thus it is possible to provide limiting surfaces which are, seen in cross-section of the side view, diagonal, increasing or decreasing to the exterior circumference, in particular to the axis of the coil, concave or even preferably not straight and not smooth. The run of the limiting surface is here, if necessary, bent in order to influence accordingly or to modify the power characteristic by this course. The influence of the magnetisable region here depends, of course, how this interacts with the permanent magnet of the armature. Thus it is, for example in a modification of the invention provided first of all that the magnetisable area is reduced with regard to the armature starting from the outside to the inside. That means that, as shown in FIG. 9, at the inside facing the armature there is still the magnetisable area (seen in radial direction with reference to the armature rod or the armature), in the exterior area there is already the non magnetic area. The course of the limiting surface, however, can be turned the other way, as it is shown in FIG. 10, where, starting inside, the thickness of the magnetic area is reduced.

In a particular alternative embodiment the weakly or non-magnetic area actually consists of two weakly or non-magnetic part areas arranged in axial direction one behind the other. In this case, only the outer edges or limiting surfaces of these areas influence the power characteristic, and thus are again diagonal and not smooth. The inner edges or interior limiting surfaces of the non-magnetic part areas to the magnetic area can have simple, preferably 45°, particularly preferably straight angle surfaces.

In order to achieve a characteristic power line in both stroke directions as uniform as possible, the weakly or non-magnetic part areas are designed uniform, preferably essentially mirror-inverted identically. A completely asymmetric power characteristic is, of course, preferably achieved with a symmetric construction of the actor according to the invention in a simple manner. In the often used asymmetric construction of the actor, however, a symmetric course of the power characteristic or an almost symmetric course of the power characteristic is reached by influencing in a suitable way through the arrangement or design of the limiting surface. According to the invention it is here the same whether the design of the limiting surface is symmetric with reference to a symmetric plane or whether it differs. The individual limiting surfaces, however, may be designed completely different in order to realise corresponding courses of the characteristic lines. Eventually, the design of the limiting surface, its orientation and the section-wise ascent forms another parameter which can be influenced in a suitable way in order to reach corresponding properties of the device according to the invention.

At this point it is pointed out, of course, that in the area of the limiting surface not only the magnetisable material changes to the non-magnetic material, but the same can also be reached in that, for example, in a compound construction first of all the magnetisable material changes, for the time being, to a less magnetisable material, what corresponds, for example, to a reduction of the thickness of the magnetisable material, to which then the non-magnetic area is linked, as described. In the invention also the selection of the material can vary in this area accordingly in order to adjust the properties of the device.

Preferably the pressure-sealed pole space, the one side of which serves for putting in the armature, is sealed by a sealing plug. This sealing plug can be made of a non-magnetisable material. However, preferably the sealing plug is made of ferromagnetic material, in order to influence the magnetic field positively and reinforcing.

Of course, the sealing plug can also be made elongated in order to change the magnetic power field.

In another preferred embodiment at least one pole disc is formed elongated toward the sealing plug, and projects in particular out of the coil form.

In a preferred embodiment for high performance magnets/actors where magnetic losses have to be reduced to a minimum, coil and pole tube are not formed separately but integrated.

In a preferred alternative embodiment the pole tube and the sealing plug each can have bearings for guiding the armature rod. Thus it is guaranteed that there is no friction of the permanent magnets or pole discs or the central disc in the cylinder-shaped pole space.

A double acting actor according to the invention has a pressure sealed design which has a working stroke similar to the convenient single-stage magnet valves. Existing production processes for magnets can be used so that an economic realisation is possible. The armature gets in a failure-proof center position when the actor is not impinged with current anymore. The direction of the force depends on the direction of the coil current and is relatively independent through a limited stroke from the position of the armature. The actor can be used for all electromagnetic actor applications requiring a bi-directional power.

It is obvious that the characteristics mentioned before and those which will be illustrated further on cannot only be imagined in the respectively given combination but also in other combinations.

### BRIEF DESCRIPTION OF THE SEVERAL VIEWS OF THE DRAWINGS

In the following the invention will be described by means of examples with regard to the corresponding drawings in further detail. In the figures:

FIG. 1 a schematic cross section of a side view of a double acting actor according to the invention,

FIG. 2 a schematic cross section of a side view of a double acting actor with graded armature,

FIG. 3 a schematic cross section of a double acting actor according to the invention with an armature rod guided in bearings,

FIG. 4 a schematic cross section of a side view of the double acting actor according to the invention with two non-magnetic part sections,

FIG. 5 a power characteristic diagram of an electromagnetic actor according to FIGS. 1 and 3,

FIG. 6 a power characteristic diagram of an electromagnetic actor according to FIG. 4,

FIG. 7 a power characteristic diagram of an electromagnetic actor according to FIG. 2,

FIG. 8 a schematic cross section of a side view of an actor according to the invention in symmetric construction and

FIGS. 9, 10 each in an enlargement a detail of an actor according to the invention.

### DETAILED DESCRIPTION OF PREFERRED EMBODIMENTS

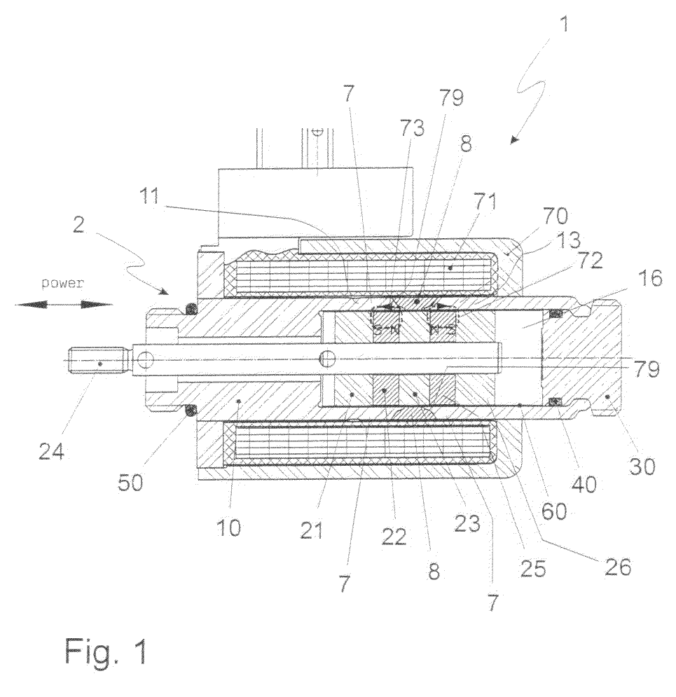

FIG. 1 shows an electro-magnetic actor 1 in a cross section of a side view. In a cylindrical pole tube 10 an armature 2 is arranged. The pole tube 10 has a pole space 16 which is closed pressure sealed to one side by a sealing plug 30 and a circular sealing 40. On the front side of the pole tube 10 opposite the sealing plug 30 there is another circular sealing 50 for sealing towards a not shown valve body which can be fixed. The valve body is operated by the armature 2.

The armature 2 comprises an armature rod 24 on which in the area of the pole tube space 16 two permanent magnets 22, 25 are arranged. Between the permanent magnets 22, 25 a central disc 23, which is made preferably of ferromagnetic material, is arranged. On the front side in axial direction to the permanent magnets each time a pole disc 21 or 26 made of ferromagnetic material is arranged.

In order to enable the pole discs 21, 26, the permanent magnets 22, 25 and the central disc 23 to glide as friction-free as possible in the cylindrical-shaped pole tube space 16, and to guide the armature rod 24 of the armature 2, the insides of the pole tube space are coated by a foil, in particular a PTFE (polytetrafluoroethylene) as bearing 60. Around the pole tube 10 a magnet body 70 with an electro-magnetic coil 71 is arranged. The pole space 16 extends from the one front side of the coil 71 to about across half of the coil 71.

In order to center the armature 2 within the pole space 16, in the exterior circumference surface or surface area of the ferromagnetic pole tube 10 a weakly or non-magnetic area 8 is provided. In the example shown here the pole tube 10 has, besides the non-magnetic area 8, also the magnetisable area 7. Between the magnetisable area 7 and the non-magnetic area 8 a limiting surface 79 is provided. The limiting surface 79 is diagonal, seen in the cross section of the side view, increasing radial to the exterior circumference, in particular designed concave to a parallel line of the movement direction of the armature 2 or coil axis of the coil 71, not straight and possibly not smooth, either. These non-straight limiting surfaces 79 or this non-straight transition leads to a power characteristic which does not depend directly on the stroke, in contrast to a power characteristic the transitions of which are designed vertically, that means radial. Edges of these transitions act like pole cores. The non-magnetic area 8 thus divides the pole tube 10 in two pole cores 11, 13. The permanent magnets 22, 25 thus each form themselves a closed magnet field 72 and 73 each with a pole core 11, 13 of the pole tube 10 which is not mirror-inverted to the non-magnetic area 8. It is obvious that the magnet field 72 and 73 each time is arranged annular to the armature axis when the coil 21 is not impinged with current.

In the frame of the definition of this application a magnetisable area 7 according to the claim is a stronger or easily magnetisable area the magnetisation of which is, as a rule, larger than the magnetisation of the non-magnetic area 8 which is possibly weakly or actually non-magnetic.

For power compensation the armature rod 24 has a passage boring 28. Alternatively, the armature could also be bored through.

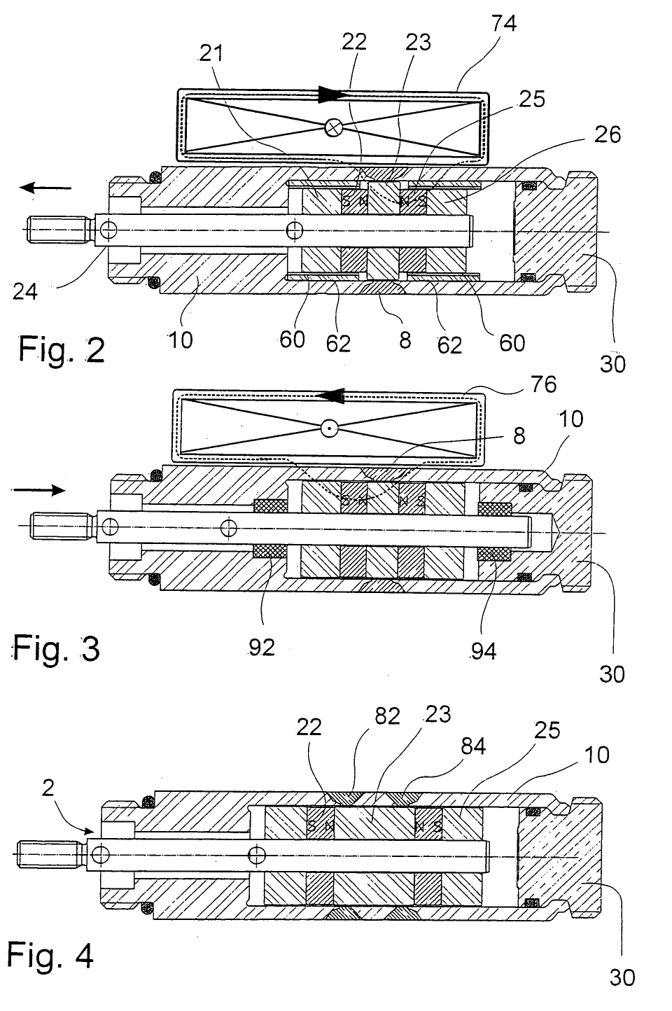

FIG. 2 shows in the schematic cross section a side view of a special embodiment of the double acting actor 1 according to the invention. This differs, compared with the embodiment according to FIG. 1, in that the central disc 23 has a larger diameter than the permanent magnets 22, 25 and the pole discs 21, 26. The pole discs 21, 26 and the permanent magnets 22, 25 are guided graded in, in particular magnetic, sleeves or sleeve-shaped bearing bushes 62. The bearing bushes 62 also have on their insides a foil preferably of PTFE, for an improved gliding.

Additionally, FIG. 2 shows in a dashed line a magnetic power flux field 74 for a movement of the armature rod 24 out of the pole tube 1. The armature is pulled out of the pole tube 10 in the arrow direction drawn, when the current is positive. The magnetic flux of the one permanent magnet 25 is reinforced by the coil 71, and the magnetic flux of the other permanent magnet 22 is reduced. The different magnet fluxes through the two pole cores 11, 13 cause a net power which pulls the armature 2 in a positive direction out of the pole tube 10.

FIG. 3 shows in contrast to that a power flux in the coil in inverse direction. The result from this is a power flux field 76 which is opposed straight to the one according to FIG. 2. The power field lines of the power flux field 76 run anticlockwise. Here the power-flux of the permanent magnet 22 is enforced, and the magnetic flux of the permanent magnet 25 is reduced. Thus the result is a stroke movement of the armature 2 into the pole tube 10. Thus the result is a movement in negative direction. The double acting actor according to FIG. 3 is additionally characterised in that the armature rod 24 is guided by means of two bearings 92 and 94. This can conveniently minimise the friction. One bearing 92 is arranged coaxial in the pole tube 10, while the second bearing 94 is set in in the sealing plug 30. Optionally it is possible to provide only one bearing 92, 94.

FIG. 4 shows the electro-magnetic double acting actor 1 in another embodiment with two non or weakly magnetic part areas 82, 84. The non or weakly magnetic area 82, 84 thus is split up and thus has an enlarging effect. Accordingly the central disc 23 is formed clearly wider. In such an embodiment only the outer limiting surfaces or the transition areas from the front sides of the pole tube 10 have an effect on the properties of the power characteristic of the actor 1. The inner edges or the interior limiting surfaces or transitions from the non-magnetic area 82, 84 to the magnetic surface area of the pole tube 10 can have simple angles, in particular 45° angles, and preferably straight surfaces. The design, however, is also realised variably, as it is, for example, shown in FIGS. 9 and 10, with regard to design and inclination of the limiting surfaces. The edges or the limiting surfaces of these transition areas act like pole cores.

The non-magnetic area 8, 82, 84 can be produced by means of different production processes. The sealing plug can be made either of ferromagnetic or non-magnetic material. The permanent magnets 22, 25 are magnetised in axial direction, and are arranged in such a way that each time identical poles are directed toward the front sides, and identical poles are directed toward opposing sides. In the present example the S poles are directed toward the outer front sides of the armature 2.

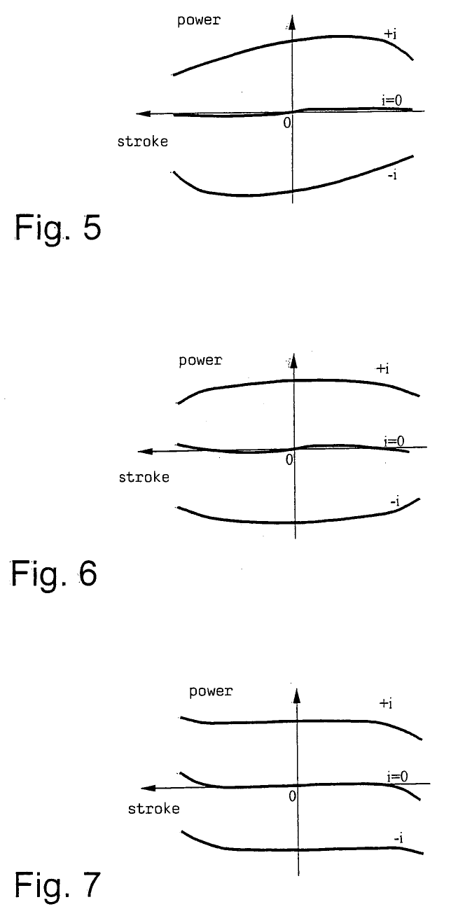

FIG. 5 shows a power characteristic diagram according to the embodiment shown in FIGS. 1 and 3. The shape of the pole core here influences the desired power characteristic. FIG. 5 shows a typical power characteristic when the pole cores 11, 13 are built in by simple angles.

FIG. 6 shows a power characteristic diagram with a flatter power characteristic. This can be reached when the pole cores 11, 13 (or differently designed limiting surfaces 19) contain two or more different angles.

FIG. 7 shows a power characteristic with a graded armature, according to the embodiment shown in FIG. 2. However, here, because the permanent magnets are designed smaller and are located farther away from the coil, the nominal power is about 15% less than the one which can be reached by a cylindrical armature shown in FIGS. 1 and 3.

By means of an electromagnetic double acting actor 1 thus a flat characteristic line with a working stroke similar to a standard magnet can be reached. The power characteristic can be optimised by the pole cores (or the limiting surfaces 79) with multiple angles. Here the pressure sealed pole tube 10 is designed similar as with standard magnets so that existing standard magnet bodies can be used. Besides, the electro-magnetic double acting actor 1 can be adjusted to all possible other sizes of construction.

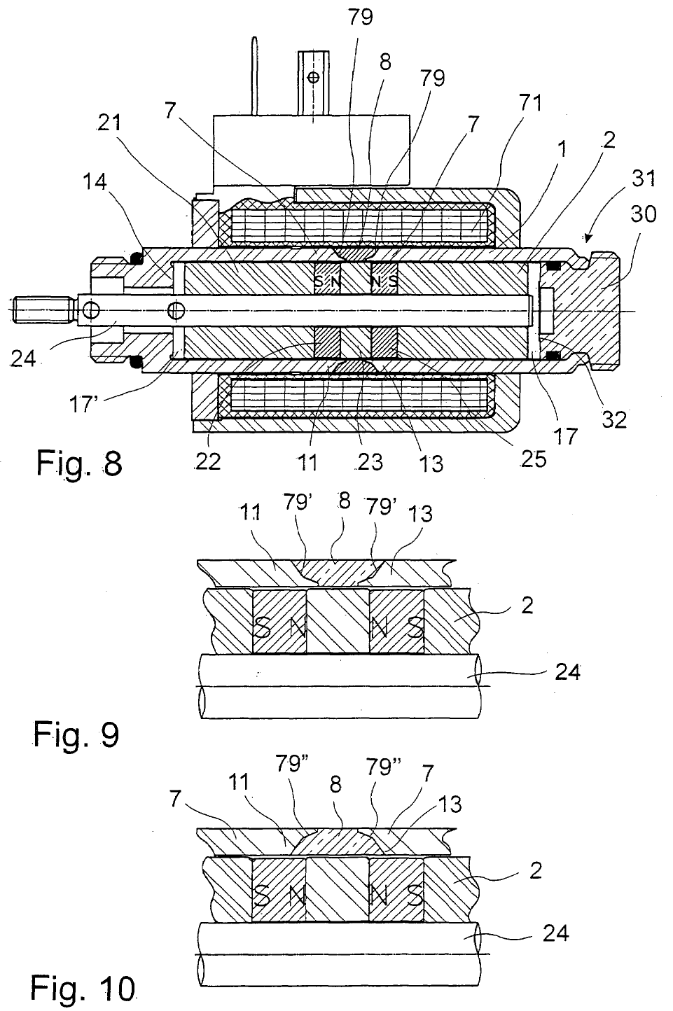

In contrast to the modification of FIG. 1 according to the invention, FIG. 8 shows a largely symmetric design of the actor according to the invention. A center plane of the coil 71 is seen here as symmetric plane orientated rectangular to the movement direction of the armature 2 or the coil axis of the coil 71. In the inoperative position, that means not in the position impinged with current, the armature 2 is positioned centric with regard to the non-magnetic area 7 as here a corresponding power balance of the different opposing magnetic powers results. Because of the symmetric construction, to the left hand side and the right hand side each time a small air gap 17 or 17′ is connected to the relatively long stretched-out armature 2 limiting the stroke of the armature to the left or right. On the left hand side there is the air gap 17′ which is between the bottom 14 of the pole tube 10 and the left disc 21.

The pole tube 10 is, similar as in FIG. 1, made of solid material which is essentially cylindrical shaped on its outer contour, and has a recess or boring on the inside for holding the armature 2.

On the right hand side the air gap 17 is limited by the contact surface 32 of the sealing plug 30 which is set in in the right, open end of the pole tube 10, and is held pressure sealed by a jamming 31 or a thread or the like. For improving the sealing quality a sealing 40 is provided.

By means of a special design of the pole cores 11, 13 the power characteristic can be adjusted accordingly. The pole cores 11, 13 are the areas of the magnetisable area 7 which are connected to the non-magnetisable area 8 and have, in particular, the limiting surface 79. Just the design of the pole cores 11, 13 in the area of the limiting surface 79 is decisive in order to influence the power characteristic accordingly. This situation is shown again enlarged in FIGS. 9, 10.

With reference to the further definition according to the invention it is provided that the armature rod 24 is arranged inside as all elements which are situated radial further away from the armature rod 24 are located accordingly outside.

In the drawing shown in FIG. 9 the thickness of the magnetisable area 7 is reduced starting from the outside to the inside. That means that in longitudinal direction of the pole, first of all, on the outside the magnetisable area is weakened, in contrast to that the interior area facing the armature 2 is still existing. The result of that is a circulatory groove in the pole tube 10 with diagonally running limiting surfaces 79′. In the example described here also the limiting surfaces are not plane, but bent. With regard to the design of this limiting surface 79′ the invention is not restricted in any way, it may be, according to the desired power characteristic, bent, formed spherically, graded, plane, conical and so on.

In contrast to that FIG. 10 shows another case of application, where the thickness of the magnetisable area 7 is reduced starting from the inside to the outside. The result here is an annular recess in the cylindrical pole tube 10 which has an undercut in the area of the magnetisable material 7 as it is indicated by the limiting surfaces 79″. Here the invention is not restricted, either, how the concrete form of these limiting surfaces 79″ is shaped.

Although the invention has been described in terms of specific embodiments which are set forth in condiserable detail, it should be understood that this is by way of illustration only and that the invention is not necessarily limited thereto, since alternative embodiments and operating techniques will become apparent to those skilled in that art in view of the disclosure. Accordingly, modifications are contemplated which can be made without departing from the spirit of the described invention.

1. Double acting electromagnetic actor (1) in particular for hydraulic and pneumatic applications, with a coil (71), an armature (2) arranged in the coil (71) with at least two permanent magnets (22, 25) magnetised in axial direction, and a central disc (23) between the permanent magnets (22, 25), wherein between the armature (2) and the coil (71) in axial direction areas (7) are provided which can be magnetised stronger or easy, and between these an area (8) forms which is weakly or non-magnetised, characterised in that the armature (2) is supported in a pole tube (10) arranged in the coil (71).

2. Double acting electro-magnetic actor according to claim 1, characterised in that the pole tube (10) is designed pressure sealed.

3. Double acting electro-magnetic actor according to claim 1, characterised in that the pole tube (10) is made of magnetisable material, and/or the pole tube (10) has the stronger or easily magnetisable areas (7) and the weakly or non-magnetisable area (8).

4. Double acting electro-magnetic actor according to claim 1, characterised by a symmetric construction of the armature (2) with reference to a central plane of the coil (71), and/or or an asymmetric construction of the armature (2) with reference to a central plane of the coil (71).

5. Double acting electro-magnetic actor according to claim 1, characterised by a symmetric construction of the strongly or easily magnetisable area (7) and the weakly or non-magnetisable area (8) with reference to a central plane of the coil (71).

6. Double acting electro-magnetic actor according to claim 1, characterised by an asymmetric construction of the strongly or easily magnetisable area (7) and the weakly or non-magnetisable area (8) with reference to a central plane of the coil (71).

7. Double acting electro-magnetic actor according to claim 1, characterised in that the weakly magnetic or non-magnetic area (8) is formed centered to a pole space (16), and/or the non-magnetic area (8) is an air gap.

8. Double acting electro-magnetic actor according to claim 1, characterised in that the non-magnetic area (8) is made of solid material, and/or the non-magnetic area (8) is made of non-magnetisable metallic material.

9. Double acting electro-magnetic actor according to claim 1, characterised in that the non-magnetic area (8) is made of non-magnetisable synthetic material or synthetic composite material, and/or the pole tube (10) is formed with the weakly or non-magnetic area (8).

10. Double acting electromagnetic actor according to claim 1, characterised in that a pole tube space (16) is provided, and projects beyond one half of the coil (71).

11. Double acting electromagnetic actor according to claim 1, characterised in that the non-magnetic area (8) is arranged in the pole tube (10) in inoperative position of the armature in axial direction about opposite the central disc (23).

12. Double acting electromagnetic actor according to claim 1, characterised in that the polarisation of the permanent magnets (22, 25) is symmetric with reference to the central disc (23), and/or the permanent magnet (22, 25) is connected to a disc (21, 26).

13. Double acting electro-magnetic actor according to claim 1, characterised in that at the front sides of the permanent magnets (22, 25) each time a disc (21, 26) is arranged connecting, and/or the disc (21, 26) connected to the permanent magnets (22, 25) is at least a ferromagnetic pole disc.

14. Double acting electro-magnetic actor according to claim 1, characterised in that a central disc (23) is provided made of a ferromagnetic material between the permanent magnets (22, 25).

15. Double acting electromagnetic actor according to claim 1, characterised in that the armature (2) has an armature rod (24) on which the discs (21, 26), the permanent magnets (22, 25) and the central disc (23) are arranged.

16. Double acting electromagnetic actor according to claim 1, characterised in that the armature (2) has an armature rod (24), and the armature rod (24) has a passage boring (28) for pressure compensation.

17. Double acting electro-magnetic actor according to claim 1, characterized in that a movement stroke of the permanent magnets (22, 25) lays within the coil (71), and/or the weakly or non-magnetic area (8) is two weak or non-magnetic part areas (82, 84) arranged in axial direction one behind the other.

18. Double acting electromagnetic actor according to claim 1, characterised in that the weakly or non-magnetic part areas (82, 84) are designed uniform, preferably essentially identically, and/or the magnetisable area (7) is connected to a limiting surface (79) at the non-magnetisable area (8), and the thickness of the magnetisable area (7) is reduced in the area of the limiting surface (79) on the armature either starting from inside to the outside, or starting from outside to the inside.

19. Double acting electro-magnetic actor according to claim 1, characterised in that a central disc (23) and pole discs (21, 26) are provided, and the central disc (23) has a larger-diameter than the pole discs (21, 26) and the permanent magnets (22).

20. Double acting electro-magnetic actor according to claim 1, characterized in that a central disc (23) is provided, and the central disc (23) has essentially the width of the non-magnetic area (8), or the central disc (23) is thicker than the non-magnetic area (4).

21. Double acting electro-magnetic actor according to claim 1, characterized in that the permanent magnets (22) and the pole discs (21, 26) each are guided in bearing bushes (62), and/or a pressure sealed pole tube space (16) is provided, and the pressure sealed pole tube space (16) is sealed by a sealing plug (30), and/or the sealing plug (30) is made of ferromagnetic material.

22. Double acting electro-magnetic actor according to claim 1, characterised in that a pressure sealed pole tube space (16) is provided, the pressure sealed pole tube space (16) is sealed by a sealing plug (30), and the sealing plug (30) is designed elongated, and/or the sealing plug (30) is made of non-magnetisable material.

23. Double acting electromagnetic actor according to claim 1, characterised in that the pole tube (10) and the sealing plug (30) have bearings (9) for guiding the armature rod (24).

24. Double acting electromagnetic actor according to claim 1, characterized in that a pressure sealed pole tube space (16) and a pole disc (26) are provided, and the pole disc (26) is designed towards the sealing plug (30) elongated, in particular extending outside the coil form (71).

25. Double acting electromagnetic actor according to claim 1, characterised in that the coil (71) and the pole tube (10) are designed integrated.
